(19) United States
(12) Patent Application Publication
(10) Pub. No.: US 2009/0144479 A1
(43) Pub. Date: Jun. 4, 2009

(54) Computer switcher and method for matching with a plurality of servers

(75) Inventors: Jishun Cui, Beijing (CN); Jian Zhang, Beijing (CN)

Correspondence Address: SCHWEGMAN, LUNDBERG & WOESSNER, P.A., P.O. BOX 2938, MINNEAPOLIS, MN, 55402, US

(73) Assignee: Lenovo (Beijing) Limited, Beijing (CN)

(21) Appl. No.: 12/315,378

(22) Filed: Dec. 2, 2008

(30) Foreign Application Priority Data
Dec. 3, 2007 (CN) 200710178655.8

(51) Int. Cl. G06F 13/00; G06F 15/173

(52) U.S. Cl. 710/316; 709/223

(57) ABSTRACT

The present invention provides a switcher for managing a plurality of servers and controlling at least one peripheral device, comprising: a transceiver module for transmitting a query instruction to one of the plurality of servers and receiving identification information of the server; and a matching module for receiving the identification information and matching a connection port between the switcher and the server with the server based on the identification information. With the present invention, automatic matching between a KVM switcher and servers can be achieved thus avoiding errors and delay which may occur during manual operations. Further, automatic matching can be performed after the connections between the servers and the KVM have been changed, without the need for excessive manual intervention.

### BACKGROUND OF THE INVENTION

1. Field of Invention

The present invention relates to server management technology, in particular to a computer switcher and method for matching with a plurality of servers.

2. Description of Prior Art

KVM (Keyboard, Video, Mouse) switchers are devices for managing the keyboards, displays (video) and mouses of a plurality of servers. The input and display of more than one server can be managed by time-sharing operation through one KVM switcher. Therefore, excessive keyboards, displays and mouses are reduced. KVM switchers play a very important role in the management of a plurality of servers.

It is necessary to establish a one-to-one correspondence between the connection ports of one KVM switcher to a plurality of servers when the KVM switcher connects to these servers. In the prior art, if any of the connected servers or the connection ports is changed, it is necessary to reconfirm the correspondence between all the servers and the connection ports of the KVM switcher, one by one. The names of the servers are then modified in the OSD (On Screen Display) menu of the KVM switcher for identification; otherwise, errors in the correspondence will lead to operation faults. There is another KVM switcher card which can be plugged on the mainboard of a server. Both the card and the server have their own IPs. However, there is no association between the two IPs. Thus, when installed on a different server, the IP of the KVM switcher card remains unchanged, while the IP of the server has already changed. Hence, it is also necessary to manually confirm the correspondence between the two IPs. A further KVM switcher is of a bus-type connection structure, where one KVM converter module is installed on each of the servers, and the respective KVM converter modules are serially connected by four pairs of twisted lines used as network cable and finally connected to the KVM switcher. Such bus-type structure also has the problem of matching between the KVM converter modules and the servers, as the identification names of the KVM converters, which are stored in the KVM converters, are still modified in the name menu of the KVM switcher. The correspondence between the KVM converters module and respective servers still needs to be rematched if any of the KVM converters is displaced onto another server.

In the prior art mentioned above, the problem of requiring match between the KVM switcher or the connection ports of the KVM switcher and servers always occurs in operation, regardless of the type of KVM switcher employed or the connection structure between the KVM switcher and the servers. Further, the manual operations during the match are not only time-consuming but also error-prone. Meanwhile, it costs time and efforts due to rematch and reconfirmation each time the connections are changed.

### SUMMARY OF THE INVENTION

The object of the present invention is to provide a computer switcher and a method for matching with a plurality of servers, which can overcome the disadvantage of being time-consuming and error-prone due to manual operations required in matching a KVM switcher with servers.

A switcher for managing a plurality of servers and controlling at least one peripheral device, comprising: a transceiver module for transmitting a query instruction to one of the plurality of servers and receiving identification information of the server; and a matching module for receiving the identification information and matching a connection port between the switcher and the server with the server based on the identification information.

A method for matching a switcher with a plurality of servers, comprising: acquiring identification information of one of the plurality servers; and matching a connection port between the switcher and the server with the server based on the identification information.

A server capable of automatic matching with a switcher, comprising: a transceiver unit for receiving a query instruction from the switcher and transmitting identification information of the server to the switcher; an acquiring unit for acquiring the identification information of the server based on the query instruction; and a passive matching unit for responding to a message generated when the switcher matches a connection port with the server based on the identification information.

With the embodiments of the present invention, automatic matching between a KVM switcher and servers can be achieved, thus avoiding errors and delay which may occur during manual operations. Further, automatic matching can be performed after the connections between the servers and the KVM have been changed, without the need for excessive manual intervention.

### BRIEF DESCRIPTION OF THE DRAWINGS

FIG. 1 is a schematic diagram showing the KVM and the servers are connected in parallel according to an embodiment of the present invention;

FIG. 2 is a schematic diagram showing the KVM and the servers are connected in serial according to an embodiment of the present invention;

FIG. 3 is a schematic diagram showing the KVM and the servers are connected via Ethernet according to an embodiment of the present invention;

FIG. 4 is a schematic diagram showing the internal connection structure of the switcher according to an embodiment of the present invention; and

FIG. 5 is a schematic flowchart showing of the method according to an embodiment of the present invention.

### DETAILED DESCRIPTION OF PREFERRED EMBODIMENTS

The objects, features and effects of the present invention will be apparent from the following detailed description of the solutions of the present invention with reference to the preferred embodiments and the drawings.

In a solution according to an embodiment of the present invention, a KVM switcher communicates with a plurality of servers and acquires automatically the names or IP addresses of the servers via the connection ports to the servers. The correspondence between the connection ports and the servers are achieved automatically at the KVM switcher side or a management software side.

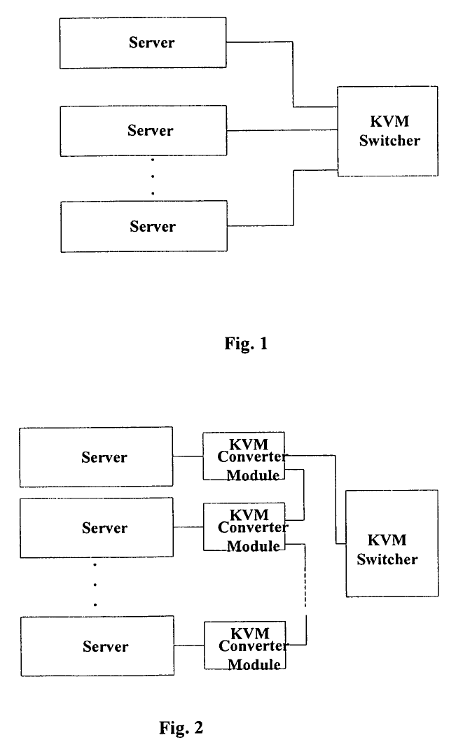

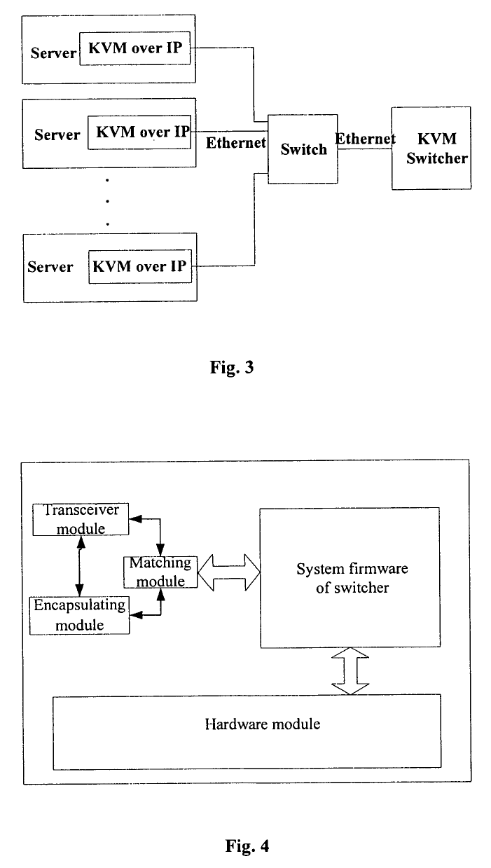

Generally, there are different connection schemes between the KVM switcher and the plurality of servers. The connection scheme shown in FIG. 1 is a parallel connection, in which each of the servers connects directly to a connection port of the switcher, and there is no connection between these servers. The connection scheme shown in FIG. 2 is a serial connection in which, to facilitate the serial connection, each server connects to one KVM converter module, with the respective KVM converter modules being serially connected to each other via network cable. In the serial connection scheme, one of the KVM converter modules connects to the KVM switcher which controls the servers through the respective KVM converter modules. The connection scheme shown in FIG. 3 is a connection in which the KVM connects to the servers via Ethernet. In such connection scheme, there is a built-in KVM over IP module within each of the servers for connecting to a switch, which is connected to the management side via the Ethernet, so that the remote control of the plurality of servers by the management side can be achieved.

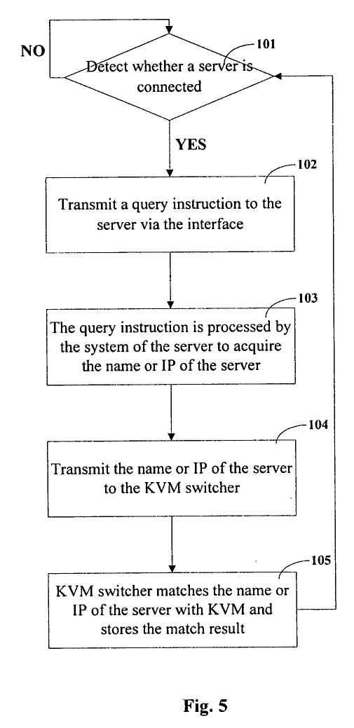

In particular, there is a transceiver module and a matching module within the KVM switcher whose internal structure is shown in FIG. 4. The matching module connects to the system firmware of the switcher for interaction, and establishes connection with the transceiver module to receive identification information from the transceiver module and to invoke micro-programs or instructions of the system firmware of the switcher based on the identification information, so as to match the connections ports between the switcher and the servers with the servers.

The transceiver module is used to transmit query instructions to the servers and to receive the identification information of the servers. It can further interact with hardware module. For example, the transceiver module can designate a buffer space in the internal memory of the hardware when transmitting/receiving data packets.

The KVM switcher can further comprise a packaging module which connects to the transceiver module and the matching module, respectively. The packaging module is used to unpackage data packets including the identification information from the transceiver module and then to deliver them to the matching module. Also, the packaging module packages the query instructions from the matching module and delivers them to the transceiver module which transmits them to the servers.

The system firmware interacts with the hardware module, and manages and controls the hardware modules through such interactions. There is an instruction module, which is used to generate a query instruction based on the command from a user. The query instruction can be packaged into data packets by the system firmware of the switcher, and the data packets, in which the query instruction is packaged, are transmitted via the connection ports located in the hardware module. The query instruction transmitted by the instruction module complies with relevant network protocols, such as TCP/IP protocol, Socket protocol or Universal Serial Bus (USB) protocol. The query instruction contains request information for inquiring the IP address or name of the server. The KVM switcher establishes communication connection with each of the servers via its connection port after connecting to the server. The instruction module in the KVM switcher transmits a query instruction to each of the servers. After receiving the query instruction, the server acquires its IP address or name based on the relevant network protocol and the request information. The IP address or name are set in a corresponding format or packaged into a data packet compliant with the relevant protocol, and then transmitted back to the KVM switcher. After the KVM switcher receives the IP address or the name of the server, the name or IP of each of the respective servers is automatically matched the connection port connected to the server and confirmed in the OSD menu or management service logic of the KVM switcher.

In the above case, the system procedure of processing the query instruction by the server can be done on any of different system levels, such as operating system, underlying firmware, or even basic input/output system (BIOS). In any of these systems, the query instruction and its response are required to comply with the transmission communication protocol. The connection port can be various types of interfaces, such as USB, Advanced System Management Interface (ASMI) of the mainboard, and Ethernet. The query instruction can be written according to a standard protocol or a customized protocol, as long as the servers and the KVM switcher are able to confirm, identify and respond to each other. For KVM card in the KVM over IP, for example, the query instruction is sent out via a USB interface between the KVM card and each of the servers, and then transmitted to the management service logic via Ethernet for matching. For the KVM switcher of serial connection type, the communication between the KVM converter modules and the servers is USB communication, and the transmission protocol between the KVM converters and the KVM switch is customized.

The above apparatus using KVM to manage a plurality of servers is a KVM switcher having an instruction module, which is used to transmit an query instruction to acquire the IP or name of each of the respective servers and to automatically match the respective servers to the connection ports of the KVM switcher based on the IPs or names.

The servers can be connected to the switcher in at least one of the following manners: each of the servers connected to the switcher via a connection line; each of the servers connected directly to one of the KVM converter modules, with these KVM converter modules serially connected to each other, and one of the converter modules connected to the switcher; and each of the servers having a built-in KVM over IP module which connects to a switch via Ethernet, and the switch connected to the switcher via the Ethernet.

Each of the servers receives the query instruction from the switcher, and acquires the identification information of the server based on the query instruction. Then, the identification information is packaged into a data packet compliant with the relevant protocol or set as data of the corresponding format and transmitted to the switcher. For example, the query instruction and the identification information will be packaged into a data packet compliant with the relevant network protocol, if the server is connected to the switcher via Ethernet. They can be packaged into a data packet to be transmitted or can be transmitted in a byte stream, if the server is connected to the switcher directly.

The server according to a preferred embodiment of the present invention at least comprises: a t a transceiver unit for receiving a query instruction from the switcher and transmitting identification information of the server to the switcher; an acquiring unit for acquiring the identification information of the server based on the query instruction; and a passive matching unit for responding to a message generated when the switcher matches a connection port with the server based on the identification information. For example, after finishing automatic match, the switcher transmits to the server test information which is responded by the passive matching unit. The connection port is a communication data interface used in establishing a connection between the switcher and the server, and includes at least Universal Serial Bus and Advanced System Management Interface.

The server may further comprise: a connection line interface through which the server is connected to the switcher with a connection line; or a KVM converter module through which the server is connected to the switcher; or a KVM over IP module, the server is connected to the switcher through the KVM over IP module and a switch in the Ethernet connect thereto.

For further description of the technology involved in the matching process performed by the apparatuses above, the implementation method will be described in the following with reference to FIG. 5. The method comprises the following steps:

In step 101, the KVM switcher or the management service logic at the KVM side detects automatically whether a new server is connected to the switcher. If yes, the process proceeds to step 102, otherwise, it returns to step 101.

The automatic detection can be a periodic detection or a KVM switcher detection triggered by the connected server.

In step 102, the KVM switcher transmits to the server, via the connection port between them, a query instruction including request information for inquiring the IP address or the name of the server.

In step 103, the query instruction from the KVM switcher is processed by the server system to acquire the name, IP or other identification which can be used to identify the server.

In step 104, the name, IP or other identification of the server is transmitted to the KVM switcher via the connection port in a predefined format or a data packet. The connection port between the KVM switcher and the server can be various data interfaces capable of communication, such as USB, ASMI and Ethernet.

The system procedure of processing the query instruction by the server can be done on different system levels, such as operating system, underlying firmware, even basic input/output system (BIOS), or other software or hardware.

In step 105, after receiving the different identification from the server, the KVM switcher matches the identification to a connection port and records the match result which is reflected in the OSD menu of the KVM switcher or the interface of the management service logic. Then, the process returns to step 101.

Next, the automatic match flow in the case where a KVM card is plugged onto a mainboard will be described to further illustrate the technical features and effects of the present invention.

First, a query instruction is transmitted to the KVM card via Ethernet by the management service logic. The KVM card then forwards the query instruction to the mainboard as a signal of USB interface in the ASMI interface of the mainboard. The query instruction is received and processed by the BIOS, firmware or software on the mainboard to acquire the identification or IP of the server host, which is then sent to the KVM card. The KVM card sends the identification to the management service logic and sends the IP of its own to management software, which matches the identification or IP of the KVM card with the identification or IP of the server connected.

The method described above ensures the automatic match of the KVM switcher with the servers connected thereto based on the connection ports. With the present invention, automatic matching between a KVM switcher and servers can be achieved thus avoiding errors and delay which may occur during manual operations. Further, automatic matching can be performed after the connections between the servers and the KVM have been changed, without the need for excessive manual intervention.

It should be noted that the foregoing embodiments is illustrative only and should not be considered as limiting the technical solutions of the present invention. The values of all the parameters can be modified according to specific circumstances and fall into the scope of the present invention. It will be understood by those skilled in the art that various changes and alternatives may be made without departing from the spirit and scope of the present invention defined by the appended claims.

What is claimed is:

1. A switcher for managing a plurality of servers and controlling at least one peripheral device, the switcher comprising:
a transceiver module for transmitting a query instruction to one of the plurality of servers and receiving identification information of the server; and
a matching module for receiving the identification information and matching a connection port between the switcher and the server with the server based on the identification information.

2. The switcher according to claim 1, further comprising:
an packaging module connected to the transceiver module and the server, for packaging the query instruction.

3. The switcher according to claim 1, wherein
the identification information includes at least one of the IP address information of the server and the name of the server.

4. The switcher according to claim 1, wherein
the peripheral device comprises at least one of a keyboard, a display device and a mouse.

5. A method for matching a switcher with a plurality of servers, comprising:
acquiring identification information of one of the plurality of servers; and
matching a connection port between the switcher and the server with the server based on the identification information.

6. The method according to claim 5, wherein
after matching the connection port with the server based on the identification information, further including step of storing match information between the switcher and the server.

7. The method according to claim 5, wherein
the identification information includes at least one of the IP address information of the server and the name of the server.

8. A server capable of automatic matching with a switcher, comprising:
a transceiver unit for receiving a query instruction from the switcher and transmitting identification information of the server to the switcher;
an acquiring unit for acquiring the identification information of the server based on the query instruction; and
a passive matching unit for responding to a message generated when the switcher matches a connection port with the server based on the identification information.

9. The server according to claim 8, wherein
the connection port is a communication data interface used when a connection is established between the switcher and the server, and includes at least Universal Serial Bus and Advanced System Management Interface.

10. The server according to claim 8, further comprising:
a connection line interface through which the server is connected to the switcher with a connection line; or
a KVM converter module through which the server is connected to the switcher; or
a KVM over IP module, the server is connected to the switcher through the KVM over IP module and a switch in the Ethernet connect thereto.
